(19) United States
(12) Patent Application Publication
(10) Pub. No.: US 2017/0220747 A1
(43) Pub. Date: Aug. 3, 2017

(54) EMERGENCY MEDICAL INFORMATION SYSTEM

(71) Applicant: MKN. LLC, West Des Moines, IA (US)

(72) Inventor: Murugan Nambiar, West Des Moines, IA (US)

(21) Appl. No.: 15/421,506

(22) Filed: Feb. 1, 2017

Related U.S. Application Data
(60) Provisional application No. 62/290,720, filed on Feb. 3, 2016.

(51) Int. Cl. G06F 19/00; G06F 21/62

(52) U.S. Cl. CPC G06F 19/324; G06F 21/6245; G06Q 50/265

(57) ABSTRACT

The present invention comprises a system and method for electronically associating emergency contact and/or medical information pertaining to an individual with said individual. More particularly, the system includes a personal identification code associated with a physical or electrical item that is in turn, associated with: the individual, a website (or an internet enabled repository) where information about the individual is stored, and a key code.

### CROSS REFERENCE TO RELATED APPLICATION

This application claims priority to United States Patent and Trademark Office Provisional Application No. 62/290,720 filed on Feb. 3, 2016

### BACKGROUND

Recent events and incidents of terrorism and natural disaster remind us how fragile human life is. They also remind us how far we've come in medical advancement for urgent and emergency care. Further, we are informed about the challenges of managing the medical and identification tasks associated with incidents where a person becomes incapacitated yet needs medical attention. Or, equally as likely, is unable to recall specific medical information or may not speak the language of the attending medical personnel, be mentally challenged or too young to be able to provide necessary contact or medical information. Emergency workers in such scenarios are left with fewer options for treatments because they are forced to use those that are the least likely to cause additional harm due to unknown medical conditions of the patient. For example, a penicillin derivative may be the drug of choice but without knowledge of allergies, the physician may, instead, elect a non-penicillin derivative. Or, worse, the medical worker may not know the patient has a pacemaker or some other condition and, by using standard emergency care, may cause injury or complications that could have easily been avoided.

### SUMMARY AND DESCRIPTION

The present invention at its broadest comprises identifying means associated with an individual that can be used to obtain medical and identification information. Unlike the traditional medical alert bracelet or I.D. card in the patient's purse or wallet, the present invention provides NO visually available personally identifying information or visually available medical identification on the patient himself Instead, the present invention provides a code that is visible on the patient's body. In one embodiment, the code is present on a temporary tattoo affixed to the skin of the patient. The tattoo also provides a website address (or information on an internet enabled repository) or, perhaps, simply means to contact an information bank. The emergency worker uses the means to access a website or otherwise contact the information bank and provides the patient's code; in return for the code, and, generally, upon verification of the medical worker's qualifications to be provided access, the medical worker is provided information particular to the patient. It is anticipated that the medical worker will be required to provide verification that he is, indeed, medical personnel with a need to know.

Although a disposable tattoo has been described as the vehicle for the code, the code could be provided to the purchaser in the form of any means upon which the code could be printed or imbedded or engraved and visibly associated with the wearer.

One use of the emergency medical information system may be event specific. For example, a marathon, a sailing regatta, a concert, etc. In this situation, the sponsor of the event may either offer as an option or require as a matter of participation a tattoo or sticker be placed in a generally specific location on the wearer's clothing or body, and further require the wearer to upload a minimum specified data set, perhaps offering the ability to enter additional information or not. Entry for the event would not be considered complete until the entrant is in compliance with the requirement. This scenario may have medical workers on stand-by who are furnished with electronic readers specific to read the unique code on the tattoo or sticker in case of injury of a participant. This type of local, event-specific use is a second embodiment of the present invention. By requiring synced information for entry, the event can provide added safety for its participants. In one embodiment the information available via the system might be a care directive, medical release, or other document pertaining to the provision of medical care executed by the Patient for emergency care; in another embodiment that information may include personal identification data, a list of the patient's medical conditions, primary physician, emergency contacts, living will, etc. In another embodiment the information may be anything the patient decided would be pertinent to the emergency caregivers in such a scenario and may include only emergency contact information.

A second embodiment may comprise uses in schools. For example, where a team is participating at an event away from the school, the players may be required to wear a tattoo or sticker which is keyed to information provided by the parent in case of emergency, thereby providing a temporary but secure means of providing information to an emergency worker if the need should arise.

The information associated with the personal identification code on the patient, nearly instantly available, would be present for patients unable to speak, or too young to provide this information or, perhaps, without the mental capacity to be able to provide such information. Having information such as blood type, allergies, artificial parts, implants, pacemakers, transplants, or any chronic or acute medical conditions could be the difference between life and death. Alternatively, just having emergency contact information could be enough to obtain release of medical information critical to survival or to obtain permissions necessary for certain procedures made necessary by an urgent situation.

### BRIEF DESCRIPTION OF THE DRAWING

FIG. 1 shows the application of means to affix a temporary identification code;

FIG. 2 is an example screen that can be completed to record medically pertinent information;

FIG. 3 is an example screen showing the information recorded;

FIG. 4 shows an example process from tattoo purchase to tattoo application;

FIG. 5 shows an exemplary process wherein an emergency worker employs the tattoo code to access the medical information.

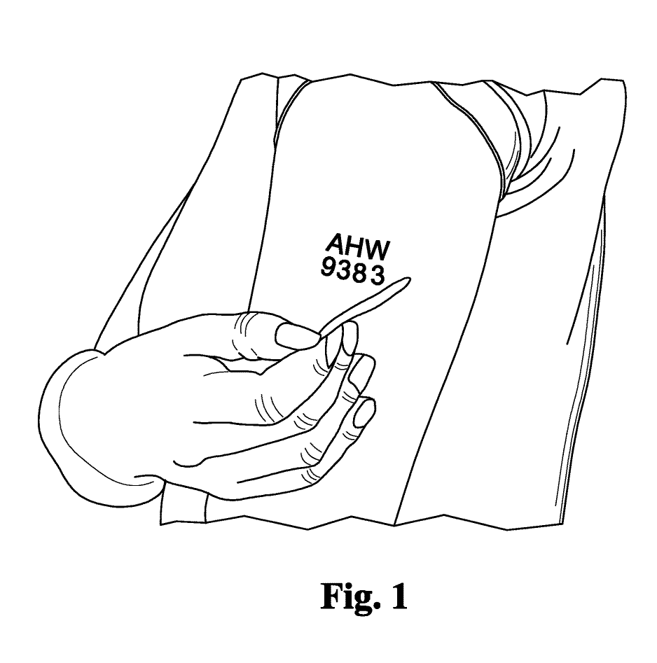

### DETAILED DESCRIPTION

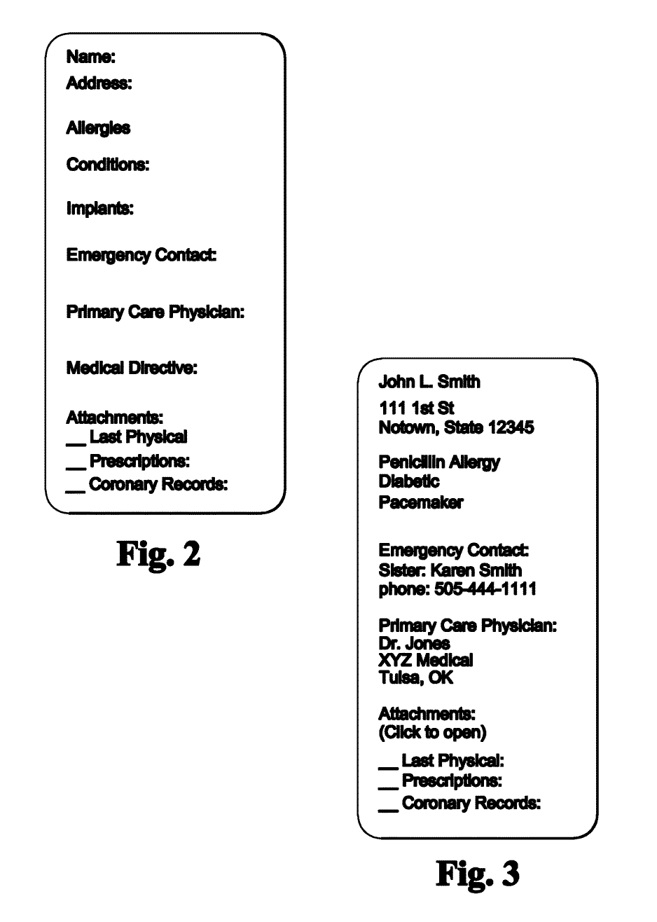

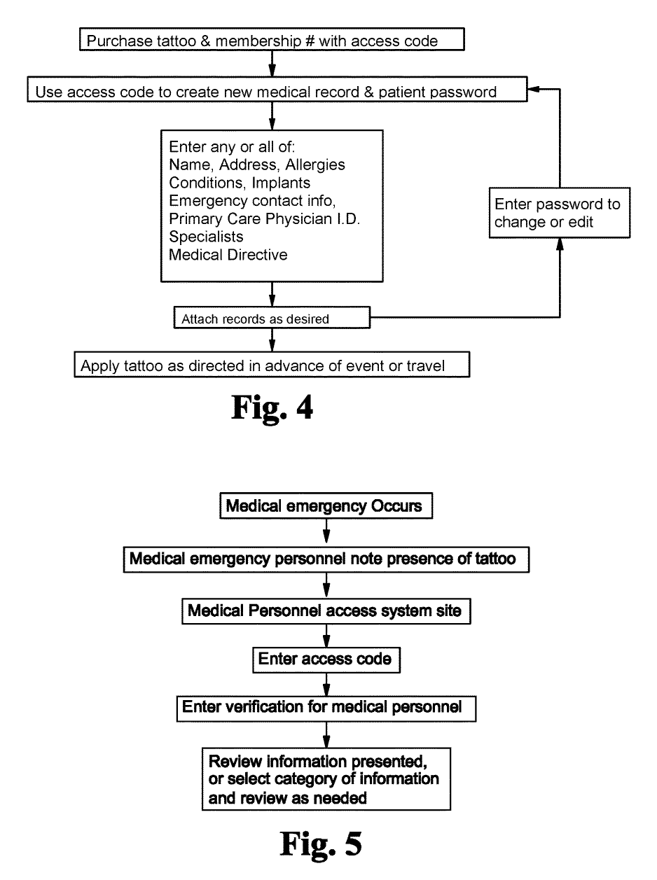

In the system 1 of the present invention, the potential patient 2 orders or is provided means to affix 4, at least temporarily, a personal identification code or 6 on his body and is provided access to means to record 100 medically pertinent information 8 (FIG. 2) ranging from identification information to detailed prescription or medical specifications at a central data repository. The personal identification code 6 may be present on said means to affix 4 which may comprise a temporary or permanent marker used by medical personnel 10 to contact the central data repository or data storage location 102 and, using the code 6 and the medical personnel's own credentials 12, access the medically pertinent information 8 recorded there (FIG. 3) for the patient matching the code 6 entered. The medically pertinent information 8 may comprise information the potential patient deems pertinent to emergency preparedness needs. Alternatively, the system 1 may present a screen with blanks to be filled, FIG. 2, each said blank labeled by the information that is required to be submitted in that field. This arrangement may provide more pertinent data in readily usable form for the medical workers 10 who are trained to look for particular information in the arrangement. Alternatively, the system 1 may require the registrant (potential patient) 2 to upload certain documents (FIG. 4) and be periodically reminded to update those requirements in an effort to provide at least a given minimum level of detail to an emergency medical worker 10. Alternatively, the patient 2 may be provided blank space in which he can decide what to upload or record via word processing capabilities and other uploading options. It is contemplated that specific fields will be provided to hold emergency contact information 8. FIGS. 3, 4. Of course, a combination of these features may be employed. In one embodiment, the site will be prepopulated with fields pertaining to various categories of information FIG. 2 and the potential patient will be able to select which fields he/she wishes to complete. As a time saving mechanism for urgent situations, these fields may be positionally and visually affixed in the application such that medical workers 10 obtaining visual access will know exactly where to look for certain information, if it is present. Further, some free space may be provided for information that does not fit in the pre-provided fields. And, attachments fields for medical records or other important paperwork such as insurance information are preferably provided (see FIGS. 2 and 3); some fields include predetermined labels of documents that may be expected to be uploaded while other fields are “free” and allow the user to create a title for what is being uploaded. In short, the potential patient 2 will be able to upload myriad medical data 8 into various fields that are pre-set and pre-located on the layout (FIGS. 2 and 3, however, these layouts are not meant to be limiting or strictly applied) so that emergency workers can locate the information they need uniformly for each person who has a code.

The system may be configured to store data entered by an individual indefinitely or to store the data only for a predetermined amount of time. The user may set the time for data destruction, or the event offering the service may set the time for data destruction. For example, the data may be set to be accessible via the personal identification code for the duration of an event such as survival training, or a rescue mission, or during a marathon. After the completion of the event, the stored data 8 may be automatically deleted. The data may be configured to store many data points, but only provide certain data points based on a security level of the medical worker gaining access to that data.

Although not required, those using the system would be encouraged to place the tattoo in one of 2 or 3 places on his/her body and medical personnel would be educated to look for these tattoos in those 2-3 general locations. a scenario describing the usage of the service is presented below but should not be considered limiting in any way:

Let us assume an emergency situation in which an individual 2 is physically incapacitated and is unable to communicate visually or verbally, and is being offered urgent care by an individual or a trained (medical) professional 10. This individual 2 is wearing a temporary tattoo 4 bearing or otherwise associated with or assigned a unique number 6 and a website address.

Under those circumstances, the individual(s) offering care 10, can leverage the temporary tattoo/tag 4 placed anywhere on the body to navigate to the website and use the unique serial number 6 to access the individual's emergency contact information 8 along with any other prior medically relevant information 8 that was keyed in or included as attachments (by the individual 2 prior to the emergency).

Steps in the process:

The individual consumer/purchaser 2 then navigates to a website to initiate the purchase of tattoos 4 which may be sold singly or in groups where upon delivery, each tattoo 4 bears a serial number or other type of personal identification code 6 which may or may not be visible to the naked eye, and the website address/URL (example—BIOTOO.ORG). The serial number/code 6 is unique to the wearer 2 and may be the same on tattoos sold together as a group, or may be selected by the purchaser or wearer 2, or may be generated by the provider of the tattoos. The serial number or code 6 may be imbedded on the temporary tattoo 4 in a visual or nonvisual manner, may comprise a bar code or other code.

Upon receipt of the tattoo(s) or other means to affix 4 and the serial number or code 6, the individual consumer navigates to the website and registers the serial number 6 associated with the tattoo. Alternatively, the serial number of the tattoo could be pre-registered prior to delivery to the individual.

With an activated serial number or code 6—the individual consumer can now employ the website to record emergency contacts (email, cell phone numbers to cite some examples) FIGS. 2, 3 and/or relevant medical information (drug allergies, chronic diseases, current prescriptions, implants, past surgeries, current chronic conditions to sight some examples) FIGS. 2, 3, and 4 using known means for data entry and/or word processing. The patient may even use the free-form portion to describe where he keeps certain important papers. The system 1 comprises means standard for uploading documents to upload current medical records and associate with the unique number 6. The individual consumer is responsible to keep this information updated. The service to register, upload, and update information is available for use with both traditional personal computers (PCs) and mobile platforms.

When a patient 2 becomes incapacitated or otherwise unable to communicate medical needs in an emergent situation, the care giver 10 may use the activated serial number or code 6 to gain access to the relevant information recorded/uploaded by the patient FIG. 3, FIG. 5.

Referring now to FIG. 5, Emergency medical service providers 10 may be equipped with a reader for the code 6 or, perhaps where visually available, will obtain the tattoo's code visually. Using the code 6, the emergency worker 10 contacts a central service, provides the code 10, verifies the legitimacy of the emergency worker, and is provided access to the medical information 8 stored therein which pertains to the individual 2 and/or access to personally identifying information 8 allowing faster access to records stored institutionally by the individual's health provider. And to information that may include emergency contacts.

In short, the present invention provides a relatively simple system for providing faster accessible information for emergency workers. Access can be as simple as verification by the medical worker of his status as a medical worker, and the use of a code to unlock the medical information about a particular individual which has been saved in the system. While quite simple in operation, the system has not heretofore been applied using a marker worn on the body to access information, and a repository for medical information as well as other information controlled and input by or about the person wearing the marker.

1. An emergency medical information system 1 comprising a permanent or temporary marker 4 associated with a person 2, said marker 4 comprising means to access information 8 electronically stored about the person.

2. The system of claim 1 wherein the information electronically stored comprises any one or more of the following; medical records, personally identifying information, emergency contact information, allergy listing, past surgical procedures, chronic health conditions, mental health information, familial health data, current medications.

3. The system of claim 2 wherein information stored may further comprise any one or more of the following: last will and testament, medical directive, medical permissions.

4. The system of claim 1 wherein the marker is purchased from a website (or a retail outlet) and is applied to a portion of a person's body.

5. The system of claim 1 wherein said means to access information comprises a code visible on the marker.

6. The system of claim 5 said code enabling access to one of a website and an internet enabled platform wherein said electronically stored data is resident in a central data repository or data storage location.

7. The system of claim 6 said code further comprising a personal identification code.

8. The system of claim 1 further comprising medical clearance procedures.

9. The system of claim 8 wherein said medical clearance procedures comprise validation of medical personnel prior to release of at least some portion of the information electronically stored by the person.

10. The system of claim 4 further comprising registration of the marker with the system.

11. The system of claim 10 wherein registration is required prior to electronically storing the information.

12. An emergency medical information system, said system specific to a single event comprising a plurality of participants over a finite amount of time, said system including a temporary marker comprising a code, said code correlated with an individual participating in said event, means for said system to access previously stored medically pertinent data about the individual said data correlated with the temporary code, and means for said system to selectively provide access by medical personnel to said medically pertinent data .

13. The system of claim 12, said event one from the following group: athletic event, marathon, concert, political rally, student trip.

14. The system of claim 12 wherein each of said plurality of participants is provided one of said temporary markers upon which the temporary code correlated with the individual appears.

15. The system of claim 12, said means to selectively provide access to medical personnel comprising a password provided only to said medical personnel.

16. The system of claim 12, further comprising means for each individual participating in the event to store medically pertinent data and associate said data with the code correlated with that individual.
